(19) United States
(12) Patent Application Publication
(10) Pub. No.: US 2013/0088742 A1
(43) Pub. Date: Apr. 11, 2013

(54) POWER SUPPLY CONTROL APPARATUS, IMAGE FORMING APPARATUS, AND POWER SUPPLY CONTROL METHOD

(71) Applicant: Atsushi KURAMOTO, Kanagawa (JP)

(72) Inventor: Atsushi KURAMOTO, Kanagawa (JP)

(21) Appl. No.: 13/626,309

(22) Filed: Sep. 25, 2012

(30) Foreign Application Priority Data
Oct. 5, 2011 (JP) 2011-221163

(51) Int. Cl. G06K 15/00

(52) U.S. Cl. 358/1.14

(57) ABSTRACT

A power supply control apparatus to control a power supply to each unit disposed in an image processing apparatus has a primary power supply unit to supply primary, a primary power detector, a transformer to convert the primary power to secondary power for each unit in the image processing apparatus, and a comparing unit that compares the detected primary power and a threshold value for the primary power set in advance and to output a signal corresponding to a comparison result. The comparing unit outputs a signal indicating that a power plug connectable to the external power source is incompletely inserted when the detected primary power is less than the threshold value.

### CROSS-REFERENCE TO RELATED APPLICATION

This application claims priority to Japanese Patent Application No. 2011-221163, filed on Oct. 5, 2011 in the Japan Patent Office, which is incorporated by reference herein in its entirety.

### BACKGROUND

1. Technical Field

The present invention relates to a power supply control apparatus, an image forming apparatus, and a power supply control method, and more particularly to detection of insertion condition of a power plug.

2. Description of the Background Art

With the advancement of information digitization, image processing apparatuses such as printers or facsimile machines for outputting digitized information and scanners for digitizing document information become indispensible apparatuses. Certain image processing apparatuses, known as multi-functional peripherals (MFP), have image capturing, image forming, and communications capabilities, which enable them to function as printers, facsimiles, scanners, copiers, or multi-functional apparatuses combining several of these capabilities.

Equipped as they are with various capabilities, MFPs typically have a complicated configuration that can complicate efforts to find and fix malfunctions when they occur. Accordingly, JP-H05-26937-A discloses a method to monitor the current supplied to each part of the apparatus, to identify malfunctioning of a control signal output unit, which controls each part of the apparatus.

More specifically, electrophotographic printers include a fusing unit having a heater to fuse toner images transferred onto a sheet of recording media. The heater is connected to the primary side of a power source, which means the heater receives a voltage not yet transformed by a power supply transformer, and thus a large current flows through the heater. Consequently, if a power plug is incompletely inserted into an outlet, the resistance at the contact between the power plug and the outlet increases, which may cause the apparatus to overheat or catch fire.

JP-2007-226056-A discloses a configuration to detect the current at the secondary side of the power source, after the voltage transformation by the power supply transformer and thus the current and voltage are small. However, the weakness of the current and voltage itself is a problem, in that it adversely affects the ability of the device to detect abnormal events with precision.

### SUMMARY

In one aspect of the invention, a power supply control apparatus to control a power supply to each unit disposed in an image processing apparatus is devised. The power supply control apparatus includes a primary power supply unit to supply primary power to a heater of a fusing unit used for fusing an image transferred on a sheet in the image processing apparatus; a primary power detector to detect the primary power supplied to the heater; a transformer to convert the primary power supplied to the image processing apparatus from an external power source to secondary power for each unit in the image processing apparatus; and a comparing unit, using a processing device, to compare the detected primary power and a threshold value for the primary power set in advance, and to output a signal corresponding to a comparison result. The comparing unit, using the processing device, outputs a signal indicating that a power plug, connectable to the external power source, is incompletely inserted when the detected primary power is less than the threshold value.

In another aspect of the invention, a method of controlling a power supply to each unit disposed in an image processing apparatus is devised. The method includes the steps of supplying primary power to a heater of a fusing unit used for fusing an image transferred on a sheet in the image processing apparatus; detecting the primary power supplied to the heater; converting the primary power supplied to the image processing apparatus from an external power source to secondary power for each unit in the image processing apparatus; comparing, using a processing device, the detected primary power and a threshold value for the primary power set in advance to output a signal corresponding to a comparison result; and outputting, using the processing device, a signal indicating that a power plug, connectable to the external power source to receive a power supply, is incompletely inserted when the detected primary power is less than the threshold value.

In another aspect of the invention, a non-transitory computer-readable storage medium storing a program that, when executed by a computer, causes the computer to execute a method of controlling a power supply to each unit disposed in an image processing apparatus, is devised. The method includes the steps of: supplying primary power to a heater of a fusing unit used for fusing an image transferred on a sheet in the image processing apparatus; detecting the primary power supplied to the heater; converting the primary power supplied to the image processing apparatus from an external power source to secondary power for each unit in the image processing apparatus; comparing, using a processing device, the detected primary power and a threshold value for the primary power set in advance to output a signal corresponding to a comparison result; and outputting, using the processing device, a signal indicating that a power plug, connectable to the external power source to receive a power supply, is incompletely inserted when the detected primary power is less than the threshold value.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 shows an overall configuration of an image processing apparatus according to an example embodiment;

FIG. 2 shows one example configuration of a power source unit according to an example embodiment;

FIGS. 3A and 3B show schematic configuration when detecting an abnormal event according to an example embodiment;

FIG. 4 shows another example configuration of a power source unit according to an example embodiment;

FIG. 5 shows another example configuration of a power source unit according to an example embodiment; and

FIGS. 6A and 6B show another schematic configuration when detecting an abnormal event according to an example embodiment;

### DETAILED DESCRIPTION OF EXEMPLARY EMBODIMENTS

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, an apparatus or system according to an example embodiment is described hereinafter.

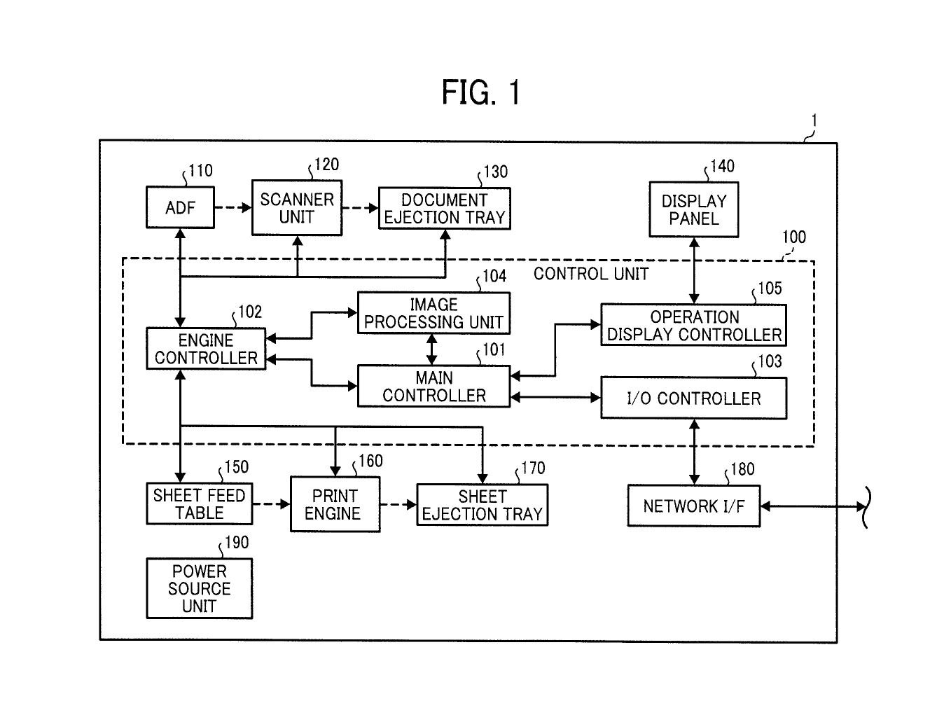

A description is given of an image processing apparatus having a print engine of electrophotography. FIG. 1 shows a block diagram of an image processing apparatus 1 according to an example embodiment. The image processing apparatus 1 may be also referred to as the image forming apparatus 1.

As shown in FIG. 1, the image processing apparatus 1 includes, for example, a control unit 100, an automatic document feeder (ADF) 110, a scanner unit 120, a document ejection tray 130, a display panel 140, a sheet feed table 150, a print engine 160, a sheet ejection tray 170, a network interface (I/F) 180, and a power source unit 190.

Further, the control unit 100 includes, for example, a main controller 101, an engine controller 102, an input/output (I/O) controller 103, an image processing unit 104, and an operation display controller 105. As shown in FIG. 1, the image processing apparatus 1 may be configured as a multi-functional apparatus including the scanner unit 120 and the print engine 160, which may be known as a multi-functional peripherals (MFP). Further, the electrical connections are shown by a solid-line arrow, and the flow of recording sheet or document sheet is shown by a dotted-line arrow in FIG. 1.

The display panel 140 can be used as an output interface, which displays a status of the image processing apparatus 1 by presenting visual information, and also used as an input interface or operation unit to input information to the image processing apparatus 1 with an operation by a user, in which the display panel 10, which may be a touch panel, displays given images such as icons or the like that can be operated by the user.

The network I/F 180 is used as an interface for the image processing apparatus 1 when the image processing apparatus 1 communicates with other apparatus or devices via the network. The network I/F 180 may be, for example, Ethernet (registered trademark), universal serial bus (USB) interface, or the like but not limited thereto.

The power source unit 190 supplies power to each part or unit disposed in the image processing apparatus 1. In an example embodiment, an abnormal event of the power source unit 190 can be detected. The detail of the power source unit 190 will be explained later.

The control unit 100 may be configured as hardware or a combination of software and hardware. Specifically, one or more software programs such as control programs, and firmware programs stored in a non-volatile memory such as ROM, HDD, and/or an optical disk can be loaded to a volatile memory such as RAM, and a central processing unit (CPU) conducts given processing using such programs, by which a software-executing controller can be configured, and the control unit 100 may be configured with a combination of software-executing controller and hardware such as an integrated circuit. The control unit 100 may function as a controller to control the image processing apparatus 1 as a whole. The control unit 100 can be configured with various types of processors, circuits, processing devices, or the like such as a programmed processor, a circuit, or an application specific integrated circuit (ASIC), used singly or in combination.

The main controller 101 controls each unit in the control unit 100 by transmitting instructions to each unit. The engine controller 120 can be used as a driver to control and drive the print engine 160, the scanner unit 120, or the like. The input/output (I/O) controller 103 inputs signals and/or instructions, input via the network I/F 180, to the main controller 101. Further, the main controller 101 controls the I/O controller 103 to access other devices via the network I/F 180.

The image processing unit 104 prepares or generates image drawing data based on to-be-output image data under the control of the main controller 101. The image drawing data is information used for drawing images when an image forming operation is conducted by the print engine 160, used as an image forming unit. The operation display controller 105 displays various types of information on the display panel 140, and reports the various information input from the display panel 140 to the main controller 101.

When the image processing apparatus 1 is operated as a printer, the I/O controller 103 may receive a print job via the network I/F 180 at first. Then, the I/O controller 103 transfers the received print job to the main controller 101. Upon receiving the print job, the main controller 101 controls the image processing unit 104 to generate image drawing data based on print data included in the print job.

When the image processing unit 104 generates image drawing data, the engine controller 102 controls the print engine 160 to conduct an image forming operation to a sheet, transported from the sheet feed table 150, based on the generated image drawing data. As such, the image processing unit 104, the engine controller 102, and the print engine 160 may collectively function as an image forming unit or an image outputting unit. Specific configuration of the print engine 160 may be, for example, an electrophotographic image forming mechanism. The sheet having received the image forming operation by using the print engine 160 may be ejected to the sheet ejection tray 170.

When the image processing apparatus 1 is operated as a scanner, the image processing apparatus 1 is input with a scanning execution instruction by a user's operation on the display panel 140, or input from an external device such as a client terminal via the network I/F 180. In response to the input of scanning execution instruction, the operation display controller 105 or the input/output controller 103 transfers a scanning execution signal to the main controller 101. The main controller 101 controls the engine controller 102 based on the received scanning execution signal.

The engine controller 102 drives the ADF 110 to transport a document sheet having a to-be-scanned image to the scanner unit 120. Further, the engine controller 102 drives the scanner unit 102 to capture or scan the image on document transported from the ADF 101. When the document sheet is not set on the ADF 110, but set directly in the scanner unit 120, the scanner unit 120 captures or scans the image on document under the control of the engine controller 102. Accordingly, the scanner unit 120 can be operated as an image capturing unit or image scanning unit.

When the scanner unit 120 conducts an image capturing operation, optically scanned document information can be captured by an image capturing device such as a charge-coupled device (CCD), and scanned image data is generated based on the optically scanned document information. The engine controller 102 transfers the scanned image data generated by the scanner unit 120 to the image processing unit 104. Under the control of the main controller 101, the image processing unit 104 generates image data based on the scanned image data received from the engine controller 102. The image data generated by the image processing unit 104 may be stored in a storage such as a HDD in the image processing apparatus 1.

The image data generated by the image processing unit 104 may be stored in the HDD or the like, or transmitted to an external apparatus such as a client terminal via the input/output controller 103 and the network I/F 180 in response to an instruction such as a user's instruction. As such, the scanner unit 120 and the engine controller 102 may function as an image input unit.

Further, when the image processing apparatus 1 is operated as a copier, the image processing unit 104 generates drawing-image data based on the scanned image data received by the engine controller 102 from the scanner unit 120, or based on the image data generated by the image processing unit 104. As similar to the printing operation, the engine controller 102 drives the print engine 160 based on the drawing-image data.

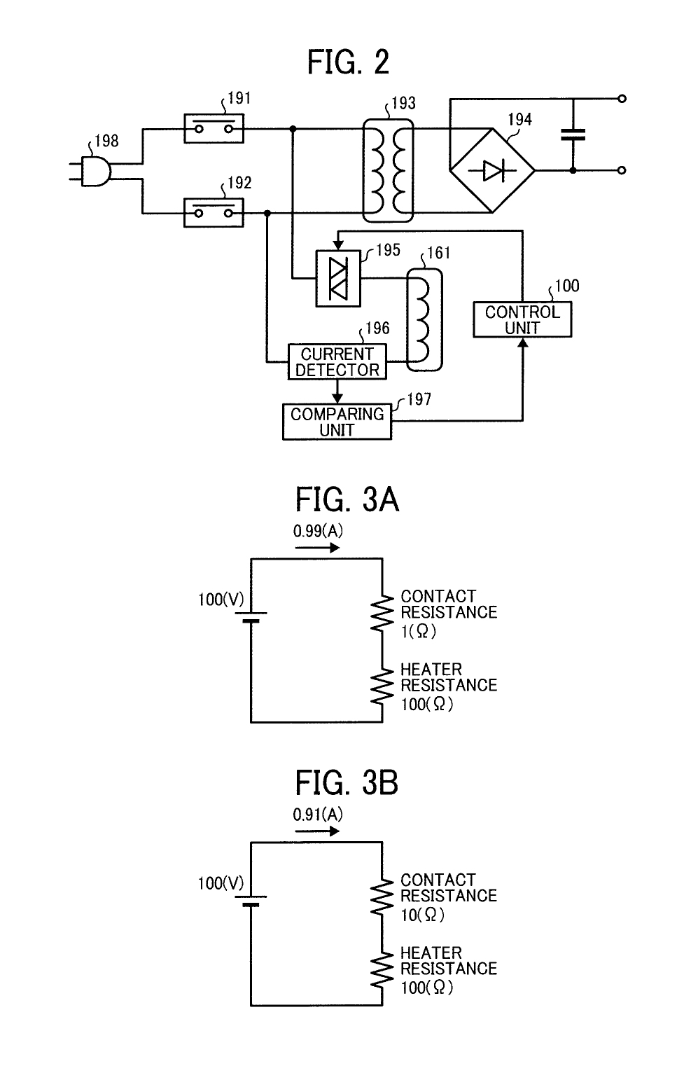

In the above described image processing apparatus 1, an abnormal event of the power source unit 190 can be detected. A description is given of detection of abnormal event of the power source according to an example embodiment with reference to FIG. 2, which shows one example circuit of the power source unit 190, and a connection configuration with a heater 161 included in the print engine 160, and the control unit 100. As shown in FIG. 2, the power source unit 190 may include power switches 191 and 192, a power supply transformer 193, a rectifier circuit 194, a triac 195, a current detector 196, and a comparing unit 197.

Each of the power switches 191 and 192 is connected right after a power plug 198, and the operation of the power switches 191 and 192 can be linked to a main power source of the image processing apparatus 1. Such power switches 191 and 192 can be used to set a connection/disconnection condition between the power plug 198 and the parts disposed after the power switches 191 and 192 in consideration of ON/OFF of the main power source of the image processing apparatus 1.

The power supply transformer 193 converts a commercial power source (or primary power) such as 100 volts (V), input via the power plug 198 and the power switches 191/192, to a secondary power. The secondary power having a given voltage is used to operate devices disposed in the image processing apparatus 1. The rectifier circuit 194 is an AC/DC converter to convert alternating current (AC) having a given voltage transformed by the power supply transformer 193 to direct current (DC).

The triac 195 is connected in parallel with the power supply transformer 193, and is connected in series with the heater 161. The triac 195 switches a power supply condition to the heater 161 based on signals input from the control unit 100.

The heater 161 can be supplied with the primary power, which is not yet converted by the power supply transformer 193. Therefore, the triac 195 and electrical lines from the power plug 198 can function as a primary power supply unit. As above described, the print engine 160 is controlled by the engine controller 102. Therefore, the engine controller 102 inputs signals to a gate of the triac 195.

The current detector 196 is connected in series with the triac 195 and the heater 161. The current detector 196 can detect a current, corresponding to the primary power, flowing through the heater 161. Such current detector 196 can be used as a primary power detector, and outputs a result of detected current.

The comparing unit 197 compares the detection result of the current detector 196 indicating the current flowing through the heater 161, and a threshold value of current set in advance. Depending on a comparison result, the comparing unit 197 outputs an abnormal event detection signal indicating the incomplete insertion condition of the power plug 198. The abnormal event detection signal output by the comparing unit 197 is input to the engine controller 102. With such a configuration, the control unit 100 can recognize the incomplete insertion condition of the power plug 198.

A description is given of a process of detecting an abnormal event with reference to FIGS. 3A and 3B. FIG. 3A shows a simplified primary side circuit of the power source unit 190, which is a left side with respect to the power supply transformer 193 of FIG. 2, when the power plug 198 is correctly inserted in the outlet, in which a contact resistance between the power plug 198 and the outlet, and the resistance of the heater 161 are shown. As shown in FIG. 3A, the primary side of power source unit 190 can be defined as a series circuit consisting of a power source of 100 V supplied via the power plug 198, the contact resistance between the power plug 198 and the outlet, and the resistance of the heater 161.

When the power plug 198 is correctly inserted in the outlet, the contact resistance may be, for example, 1(Ω). If the resistance of the heater 161 is set at 100(Ω), the current detected by the current detector 196 becomes almost 0.99(A), by computing 100(V)/(1(Ω)+100(Ω)).

In contrast, FIG. 3B shows a simplified primary side circuit of the power source unit 190, which is a left side with respect to the power supply transformer 193 of FIG. 2, when the power plug 198 is not correctly inserted (e.g., is not completely inserted) in the outlet, in which a contact resistance between the power plug 198 and the outlet, and the resistance of the heater 161 are shown. When the power plug 198 is at the incomplete insertion condition, the contact resistance may become, for example, 10(Ω), and the current detected by the current detector 196 becomes almost 0.91(A) by computing 100(V)/(10(Ω)+100(Ω)).

As such, depending on the insertion condition of the power plug 198, the contact resistance fluctuates. As a result, the current detected by the current detector 196 fluctuates. The fluctuation may be on the order of 10⁻² ampere (A), for example. Therefore, by setting a threshold value that can detect such fluctuation in the comparing unit 197, the incomplete insertion condition of the power plug 198 can be detected easily.

In the above example, a threshold value of current set for the comparing unit 197 may be, for example, 0.91(A), 0.93(A), and 0.95(A). When the current detected by the current detector 196 becomes the threshold value or less, the comparing unit 197 outputs the abnormal event detection signal.

The threshold value of current set for the comparing unit 197 can be computed based on the fluctuation of the contact resistance. For example, when the normal value of the contact resistance is set 1(Ω) as above mentioned, it is determined that the power plug 198 is in the incomplete insertion condition if the contact resistance becomes, for example, 5(Ω) or more, which is five times or more of the normal value of 1(Ω).

If the contact resistance is 5(Ω), the current flowing through the heater 161 becomes 0.95(A) by computing 100(V)/(5(Ω)+100(Ω)). In such a case, by setting the threshold value of 0.95(A) in the comparing unit 197, it can be detected that the power plug 198 is at the incomplete insertion condition when the contact resistance becomes 5(Ω).

When the incomplete insertion condition of the power plug 198 is detected as such, and the abnormal event detection signal is input to the engine controller 102, the main controller 101 can recognize that the power plug 198 is at the incomplete insertion condition based on the received abnormal event detection signal. When the main controller 101 recognizes that the power plug 198 is at the incomplete insertion condition, the main controller 101 controls the operation display controller 105 to display an alarm screen on the display panel 140 to notify a user that the power plug 198 is at the incomplete insertion condition. With such configuration, the user can recognize that the power plug 198 is at the incomplete insertion condition.

Further, in addition to displaying the alarm screen on the display panel 140, the user can be alarmed that the power plug 198 is at the incomplete insertion condition by generating an alarm sound, and emitting light from a light emitting diode (LED). Such alarm operations can be controlled by the main controller 101.

In the configuration shown in FIG. 2, the current detector 196 and the comparing unit 197 are supplied with a given operation voltage, which is prepared by conducting a voltage transformation by the power supply transformer 193. As above described, the primary side voltage, not yet converted by the power supply transformer 193, is, for example, 100 V. Therefore, circuits operated on the primary side require elements having high dielectric resistance, by which the circuit cost increases.

The current detector 196 requires a high dielectric resistance element for one or more parts used for detecting current, but one or more parts for generating and outputting a signal of detection result can be configured without considering the primary side voltage such as 100 V.

Further, the comparing unit 197 receives a detection signal from the current detector 196, and compares the received signal with a threshold value of current set in advance, and can output the abnormal event detection signal depending on the comparison result. Therefore, the comparing unit 197 can be configured without considering the primary side voltage such as 100 V.

Therefore, although the current detector 196 and the comparing unit 197 are disposed at the primary side, the operation voltage to operate the current detector 196 and the comparing unit 197 can be supplied from the secondary power source, which has received the voltage transformation by the power supply transformer 193. Therefore, elements of the current detector 196 and the comparing unit 197 can be configured using low dielectric resistance elements, by which the circuit cost can be reduced.

As above described, the image processing apparatus 1 includes the power source unit 190, which can be referred to as a power supply control apparatus. In the power source unit 190, it is determined whether the power plug 198 is at the incomplete insertion condition based on the fluctuation of current at the primary side, which is a current not yet received the voltage transformation by the power supply transformer 193. Therefore, the incomplete insertion condition of the power plug 198 can be detected with high precision.

In the above described example embodiment, the comparing unit 197 outputs the abnormal event detection signal to the engine controller 102, and then the control unit 100 activates an alarm to notify the abnormal event to a user.

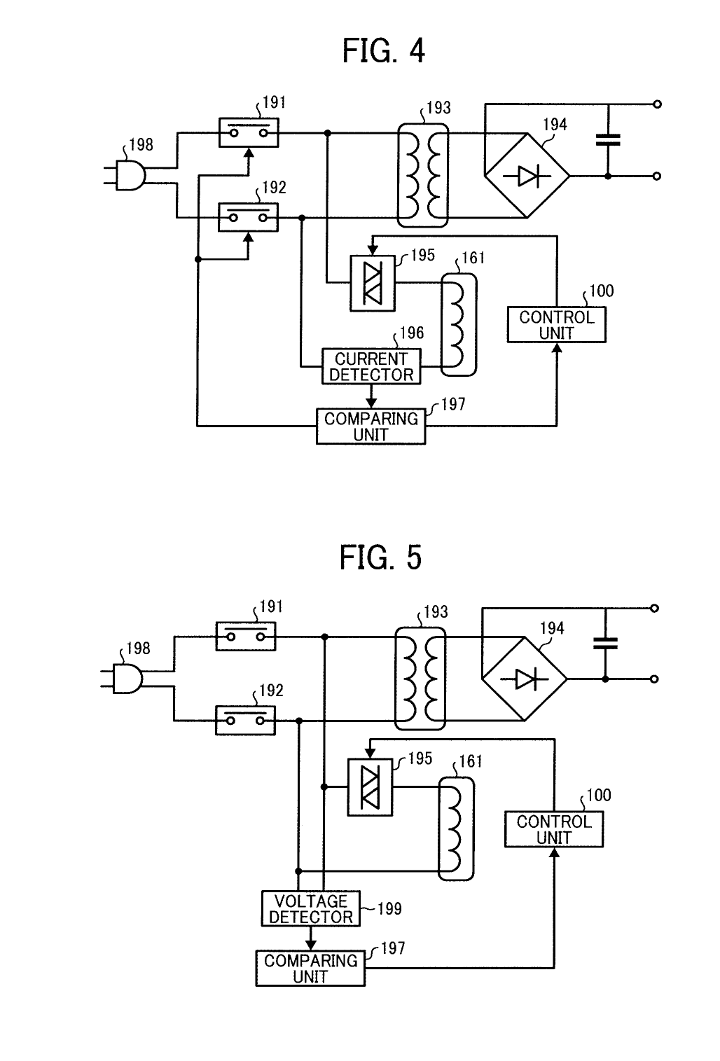

Further, by compulsory shutting down the power source of the image processing apparatus 1, accidents such as overheat and catching fire can be prevented. Such function can be devised, for example, by using another configuration shown in FIG. 4, in which the comparing unit 197 outputs the abnormal event detection signal to the power switches 191 and 192. Upon receiving the abnormal event detection signal, the power switches 191 and 192 can be deactivated to shut down the power supply supplied from the power plug 198. As such, the comparing unit 197 and the power switches 191 and 192 can collectively function as a shutdown unit to shut down a power supply from the external power source when the signal indicating the incomplete insertion condition of the power plug is detected.

Further, in another case, based on the abnormal event detection signal, the engine controller 102 controls the triac 195 to stop the power supply to the heater 161, by which the similar effect can be obtained.

In the above described example embodiment, depending on the current detection result by the current detector 196, the comparing unit 197 outputs the abnormal event detection signal.

Further, instead of the current detection result, the comparing unit 197 can output the abnormal event detection signal based on the detection result of voltage. A description is now given of using the voltage detection result.

FIG. 5 shows another circuit of the power source unit 190, and a connection configuration of the heater 161 included in the print engine 160, and the control unit 100. Instead of the current detector 196 shown in FIG. 2, a voltage detector 199 is disposed in the configuration of FIG. 5, in which one end of the voltage detector 199 is connected between the power switch 191 and the triac 195, and the other end of the voltage detector 199 is connected between the power switch 192 and the heater 161. With such a configuration, the voltage detector 199 can detect the voltage applied to the heater 161, and outputs the detection result of voltage. As such, the voltage detector 199 can be used as a primary power detector to detect the primary power applied or supplied to the heater 161, and outputs a result of detected voltage.

In the configuration of FIG. 5, the comparing unit 197 compares the detection result by the voltage detector 199 indicating the voltage applied to the heater 161, and a threshold value of voltage set in advance, and outputs the abnormal event detection signal depending on a comparison result. The abnormal event detection signal output by the comparing unit 197 can be used as similar to other configurations shown in FIGS. 2 and 4. As such, in the configuration shown in FIG. 5, based on the voltage of the heater 161, an effect explained with FIGS. 2 and 4 can be obtained similarly.

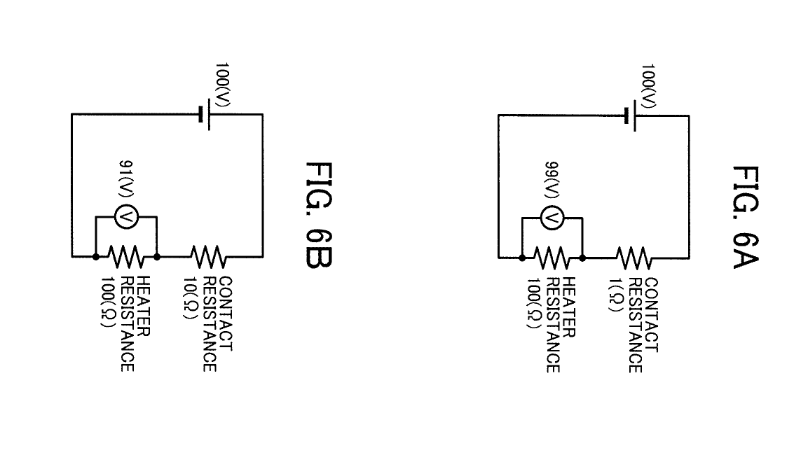

A description is given of a process of abnormal event detection in the configuration of FIG. 5 with reference to FIGS. 6A and 6B. FIG. 6A shows a simplified primary side circuit of the power source unit 190, which is a left side with respect to the power supply transformer 193 of FIG. 5, when the power plug 198 is correctly inserted in the outlet, in which a contact resistance between the power plug 198 and the outlet, and the resistance of the heater 161 are shown. As shown in FIG. 6A, the primary side of the power source unit 190 can be defined as a series circuit consisting of a power source of 100 V supplied via the power plug 198, the contact resistance between the power plug 198 and the outlet, and the resistance of the heater 161.

When the power plug 198 is correctly inserted in the outlet, the contact resistance may be, for example, 1(Ω). If the resistance of the heater 161 is set at 100(Ω), the voltage detected by the voltage detector 199 becomes almost 99(V) by computing 100(Ω)×(100(V)/(1(Ω)+100(Ω)).

In contrast, FIG. 6B shows a simplified primary side circuit of the power source unit 190, which is a left side with respect to the power supply transformer 193 of FIG. 5, when the power plug 198 is not correctly inserted (e.g., is not completely inserted) in the outlet, in which a contact resistance between the power plug 198 and the outlet, and the resistance of the heater 161 are shown. When the power plug 198 is at the incomplete insertion condition, the contact resistance may become, for example, 10(Ω). Then, the voltage detected by the voltage detector 199 becomes almost 91(V) by computing 100(Ω)×(100(V)/(10(Ω)+100(Ω)).

As such, depending on the insertion condition of the power plug 198, the contact resistance fluctuates. As a result, the voltage detected by the voltage detector 199 fluctuates. The fluctuation may occur, for example, on the order of one volt (V). Therefore, by setting a threshold value that can detect such fluctuation in the comparing unit 197, the incomplete insertion condition of the power plug 198 can be detected easily. The threshold value of voltage set in the comparing unit 197 can be set as similar to the configurations of FIGS. 2 and 4.

Further, in the configuration of FIG. 5, one end of the voltage detector 199 is connected at a position near to the power plug 198 compared to the triac 195. Therefore, although the heater 161 is not supplied with power when the triac 195 is at the OFF state, the voltage can be detected. Further when the triac 195 becomes the ON state, and the heater 161 is supplied with power, the voltage to be supplied to the heater 161 can be detected.

Further, the voltage detector 199 can be connected at both ends of the heater 161. In such a case, when the triac 195 is at the OFF state, the voltage of the heater 161 cannot be detected, but the voltage applied to the heater 161 can be detected more precisely.

In the above described example embodiment, the incomplete insertion condition of a power plug can be detected correctly.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a Wireless Application Protocol (WAP) or 3G-compliant phone) and so on. Since the present invention can be implemented as software, each and every aspect of the present invention thus encompasses computer software implementable on a programmable device.

The computer software can be provided to the programmable device using any storage medium for storing processor readable code such as a flexible disk, a compact disk read only memory (CD-ROM), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a solid state memory device or the like, but not limited these.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In the above-described example embodiment, a computer can be used with a computer-readable program, described by object-oriented programming languages such as C++, Java (registered trademark), JavaScript (registered trademark), Perl, Ruby, or legacy programming languages such as machine language, assembler language to control functional units used for the apparatus or system. For example, a particular computer (e.g., personal computer, work station) may control an information processing apparatus or an image processing apparatus such as image forming apparatus using a computer-readable program, which can execute the above-described processes or steps. In the above described embodiments, at least one or more of the units of apparatus can be implemented in hardware or as a combination of hardware/software combination. In example embodiment, processing units, computing units, or controllers can be configured with using various types of processors, circuits, processing devices, processing circuits or the like such as a programmed processor, a circuit, an application specific integrated circuit (ASIC), used singly or in combination. A circuit is a structural assemblage of electronic components including conventional circuit elements, integrated circuits including application specific integrated circuits, standard integrated circuits, application specific standard products, and field programmable gate arrays. Further a circuit includes central processing units, graphics processing units, and microprocessors which are programmed or configured according to software code. A circuit does not include pure software, although a circuit does include the above-described hardware executing software.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. A power supply control apparatus to control a power supply to each unit disposed in an image processing apparatus, comprising:
a primary power supply unit to supply primary power to a heater of a fusing unit used for fusing an image transferred on a sheet in the image processing apparatus;
a primary power detector to detect the primary power supplied to the heater;
a transformer to convert the primary power supplied to the image processing apparatus from an external power source to secondary power for each unit in the image processing apparatus; and
a comparing unit, using a processing device, to compare the detected primary power and a threshold value for the primary power set in advance, and to output a signal corresponding to a comparison result,
wherein the comparing unit, using the processing device, outputs a signal indicating that a power plug, connectable to the external power source, is incompletely inserted when the detected primary power is less than the threshold value.

2. The power supply control apparatus of claim 1, wherein the primary power detector and the comparing unit are operable by the secondary power provided by the transformer.

3. The power supply control apparatus of claim 1, wherein the primary power supply unit stops supply of the primary power to the heater when the signal indicating that the power plug is incompletely inserted is detected.

4. The power supply control apparatus of claim 1, further comprising a shutdown unit to shut down the primary power from the external power source to the image processing apparatus when the signal indicating that the power plug is incompletely inserted is detected.

5. The power supply control apparatus of claim 1, wherein the primary power detector detects current flowing through the heater when the image processing apparatus is conducting an image forming operation.

6. The power supply control apparatus of claim 1, wherein the primary power detector detects voltage applied to the heater when the image processing apparatus is conducting an image forming operation.

7. An image processing apparatus, comprising the power supply control apparatus of claim 1.

8. A method of controlling a power supply to each unit disposed in an image processing apparatus, the method comprising the steps of:
supplying primary power to a heater of a fusing unit used for fusing an image transferred on a sheet in the image processing apparatus;
detecting the primary power supplied to the heater;
converting the primary power supplied to the image processing apparatus from an external power source to secondary power for each unit in the image processing apparatus;
comparing, using a processing device, the detected primary power and a threshold value for the primary power set in advance to output a signal corresponding to a comparison result; and
outputting, using the processing device, a signal indicating that a power plug, connectable to the external power source to receive a power supply, is incompletely inserted when the detected primary power is less than the threshold value.

9. A non-transitory computer-readable storage medium storing a program that, when executed by a computer, causes the computer to execute a method of controlling a power supply to each unit disposed in an image processing apparatus, the method comprising the steps of:
supplying primary power to a heater of a fusing unit used for fusing an image transferred on a sheet in the image processing apparatus;
detecting the primary power supplied to the heater;
converting the primary power supplied to the image processing apparatus from an external power source to secondary power for each unit in the image processing apparatus;
comparing, using a processing device, the detected primary power and a threshold value for the primary power set in advance to output a signal corresponding to a comparison result; and
outputting, using the processing device, a signal indicating that a power plug, connectable to the external power source to receive a power supply, is incompletely inserted when the detected primary power is less than the threshold value.
